(19) United States
(12) Patent Application Publication
(10) Pub. No.: US 2018/0003441 A1
(43) Pub. Date: Jan. 4, 2018

(54) METHOD FOR MANUFACTURING A NICKEL-TITANIUM ALLOY USING A HIGH VACUUM CRUCIBLELESS LEVITATION MELTING PROCESS

(71) Applicant: METAL INDUSTRIES RESEARCH & DEVELOPMENT CENTRE, Kaohsiung (TW)

(72) Inventors: Chao-Hsien HUANG, Kaohsiung (TW); Weng-Sing HWANG, Kaohsiung (TW); Guan-Ping QI, Kaohsiung (TW); Chien-Tzu CHENG, Kaohsiung (TW); Yu-Ting HUNG, Kaohsiung (TW)

(21) Appl. No.: 15/358,907

(22) Filed: Nov. 22, 2016

(30) Foreign Application Priority Data
Jul. 1, 2016 (TW) 105120984

(51) Int. Cl. F27D 7/06; F27D 11/06; F27D 27/00; C22C 1/02; F27D 19/00; F27D 7/02

(52) U.S. Cl. CPC F27D 7/06; F27D 19/00; F27D 7/02; F27D 27/00; C22C 1/023; F27D 11/06; F27D 2007/066; F27D 2019/0003

(57) ABSTRACT

A method for manufacturing a nickel-titanium alloy includes steps of: placing a titanium material on a first bracket, and placing a nickel material on a second bracket; vacuumizing the vacuum confined space of the melting chamber to below a pressure of 10⁻⁵ Torr, and lifting up the titanium material placed on the first bracket to a working area of an induction coil; introducing inert gases; starting the induction coil, to make the titanium material in a levitation state and electromagnetically stirred and heated; dropping the first bracket; measuring whether the temperature of the working area of the induction coil reaches a predetermined temperature range; when the first active metal is in the half molten state, dropping the nickel material placed on the second bracket to be added to the titanium material, and obtaining a homogenizing nickel-titanium alloy by means of electromagnetic stirring and heating; and recycling the homogenizing nickel-titanium alloy.

### CROSS-REFERENCE TO RELATED APPLICATION

This application claims the benefit of Taiwan Patent Application No. 105120984, filed on Jul. 1, 2016, which is hereby incorporated by reference for all purposes as if fully set forth herein.

### BACKGROUND

### Technical Field

The present disclosure relates to a method for manufacturing a nickel-titanium alloy, and particularly to a method for manufacturing a nickel-titanium alloy using a high vacuum crucibleless levitation melting process.

### Related Art

The existing atmospheric levitation melting process mostly conducts a related levitation melting process for aluminum and copper. As the two above-mentioned materials are easy to get and at a lower cost, many uncertainty variables are lacked compared with a high-valued active alloy (e.g., titanium alloy, nickel-titanium alloy or cobalt-base alloy) levitation melting process.

US Patent reference (U.S. Pat. No. 5,722,481) mainly discloses that the molten metal in a levitation melting furnace is cast through a suction pipe immersed in the levitation melting furnace. The molten metal is from a double-structure mold chamber arranged directly above the levitation melting furnace, and the mold chamber is a mold having a gas permeability. The molten metal is levitation-molten in an inert atmosphere under atmospheric pressure. An outer mold chamber of the double-structure mold chamber is connected to the levitation melting furnace. Pressure in the outer mold chamber and an inner mold chamber of the double-structure mold chamber and in an upper space in the levitation melting furnace is reduced to below atmospheric pressure. The suction pipe is arranged in the inner mold chamber and communicated with the mold chamber to be immersed into the molten metal. The molten metal is cast into the mold chamber under an increased pressure by blowing an inert gas into the upper space in the melting furnace. The inner mold chamber is lifted up, thereby pulling the suction pipe from the molten metal. The outer mold chamber, after returning to atmospheric pressure, is separated from the levitation melting furnace. In the prior art of the patent, an alloy material is prepared in a push and pull way, and protected by using a blowing method, and if an inert gas chemically reacts with the material surface, a higher temperature is required to completely remove the reaction layer. However, the US Patent reference (U.S. Pat. No. 5,722,481) of the patent lacks a high vacuum and precise control mode for the whole manufacturing device, because the titanium alloy belongs to high-activity titanium in high-temperature environments, and if not well controlled, the titanium alloy is easily bonded to oxygen in the atmosphere, so that an outer layer has poor uniformity. Using cold crucible levitation melting can improve the melting weight, but a contact melting method is difficult to ensure that the obtained alloy material can avoid contamination of the crucible and thus affects the overall quality.

In view of this, it is necessary to provide a method for manufacturing a nickel-titanium alloy using a high vacuum crucibleless levitation melting process, to effectively solve the foregoing problems.

### SUMMARY

A main objective of the present disclosure is to provide a method for manufacturing a nickel-titanium alloy using a high vacuum crucibleless levitation melting process, to eliminate contamination caused by gas molecules and the crucible to an active alloy.

To achieve the above objective, the present disclosure provides a method for manufacturing a nickel-titanium alloy using a high vacuum crucibleless levitation melting process, including steps of: placing a titanium material on a first bracket, and placing a nickel material on a second bracket, so as to make the titanium nickel and materials located in a vacuum confined space of a melting chamber; vacuumizing the vacuum confined space of the melting chamber to below a pressure of 10⁻⁵ Torr, and lifting up the titanium material placed on the first bracket to a working area of an induction coil; introducing inert gases, to prevent the titanium material from producing an oxidization reaction in a subsequent high-temperature process; starting the induction coil, to make the titanium material in a levitation state and electromagnetically stirred and heated; dropping the first bracket, to make the titanium material stably levitate and electromagnetically stirred and heated; measuring whether the temperature of the working area of the induction coil reaches a predetermined temperature range between 1200-1600° C., to confirm whether the first active metal is in a half molten state; when the first active metal is in the half molten state, dropping the nickel material placed on the second bracket to be added to the titanium material, and obtaining a homogenizing nickel-titanium alloy by means of electromagnetic stirring and heating; and recycling the homogenizing nickel-titanium alloy automatically or manually, to accomplish a high vacuum crucibleless levitation melting process.

The high vacuum crucibleless levitation melting process refers to a technology with which the device and method for manufacturing an active alloy of the present disclosure use electromagnetic fields to make the nickel-titanium alloy in a levitation state and heated during high vacuum melting. The high vacuum melting technology eliminates contamination of gas molecules to the nickel-titanium alloy, and the levitation melting technology further eliminates contamination caused by the crucible on this basis. The high vacuum crucibleless electromagnetic levitation melting eliminates contamination of gas molecules and the crucible, and is an ideal technology for manufacturing medical alloy material.

In order to make the foregoing and other objectives, features and advantages of the present disclosure more evident, detailed description is provided below with reference to the accompanying drawings.

### BRIEF DESCRIPTION OF THE DRAWINGS

FIG. 1 is a perspective schematic view of a device for manufacturing an active alloy according to an embodiment of the present disclosure;

FIG. 2a and FIG. 2b are perspective schematic views of a melting chamber according to an embodiment of the present disclosure;

FIG. 3 is a flowchart of a method for manufacturing a nickel-titanium alloy using a high vacuum crucibleless levitation melting process according to an embodiment of the present disclosure;

FIG. 4 is a partial plan schematic view of a melting chamber according to an embodiment of the present disclosure, which shows opening a chamber door;

FIG. 5 is a plan schematic view of a melting chamber according to an embodiment of the present disclosure, which shows lifting up a titanium material to a working area of an induction coil; and

FIG. 6 is a partial plan schematic view of a melting chamber according to an embodiment of the present disclosure, which shows pushing a recycling seat body of a material recycling seat to the middle of a chamber base of a melting chamber.

### DETAILED DESCRIPTION

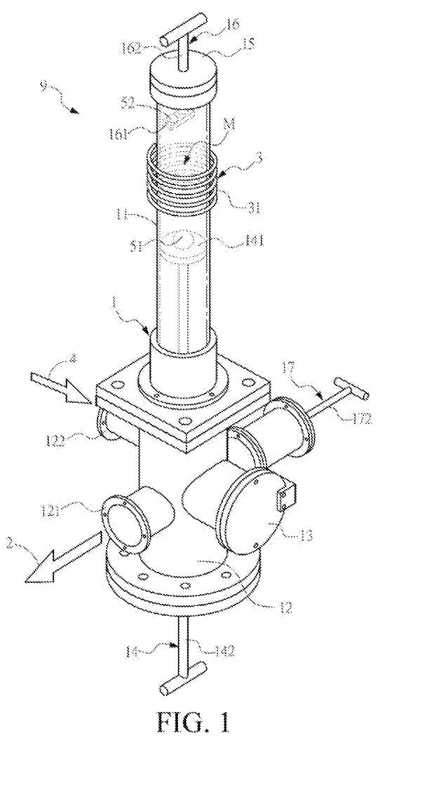

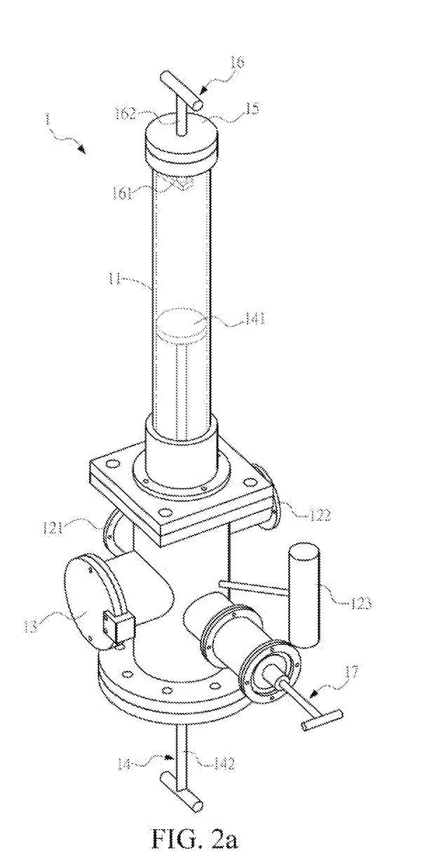

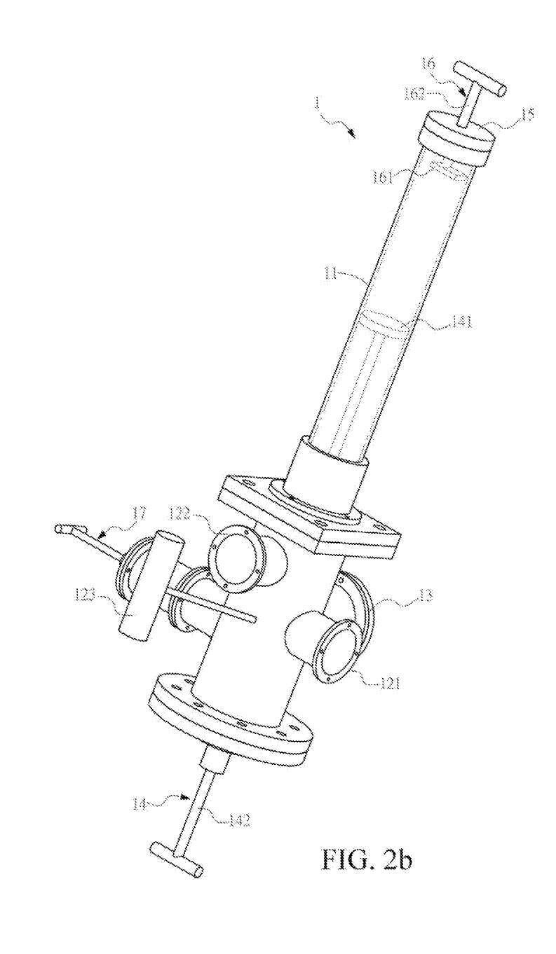

FIG. 1 is a perspective schematic view of a device for manufacturing an active alloy (e.g., nickel-titanium alloy) according to an embodiment of the present disclosure. FIG. 2a to FIG. 2b are perspective schematic views of a melting chamber according to an embodiment of the present disclosure. The device 9 for manufacturing an active alloy (e.g., nickel-titanium alloy) includes a melting chamber 1, a vacuum pump unit 2, a high-frequency furnace 3 and an inert gas supply unit 4. The melting chamber 1 includes a working pipe 11 (e.g., a quartz tube made of a transparent material), a chamber base 12, a chamber door 13, a first bracket 14, a pipe cover 15, a second bracket 16 and a material recycling seat 17.

The working pipe 11 is surrounded by an induction coil 31 and forms with a working area M. The chamber base 12 is disposed below the working pipe 11 and communicated with the working pipe 11. The chamber base 12 includes a gas inlet hole 122, a vacuum pump connection port 121 and a vacuum sensor 123. The gas inlet hole 122 is used for introducing inert gases (e.g., argon and helium) into the working pipe 11. The vacuum pump connection port 121 is used for making a vacuum degree in the working pipe 11 below a pressure of 10⁻⁵ Torr. The vacuum sensor 123 is used for measuring the vacuum degree in the working pipe 11.

The chamber door 13 is communicated with the chamber base 12, for placing a first active metal 51 (e.g., titanium material) into the chamber base 12. The first bracket 14 passes through the chamber base 12 and can move towards a direction away from or near the working area M, for lifting up the position of the first active metal 51 into the working pipe 11. The pipe cover 15 is disposed above the working pipe 11, for placing a second active metal 52 (e.g., nickel material) into the working pipe 11. The second bracket 16 passes through the pipe cover 15, extends into the working pipe 11, and can move towards a direction away from or near the working area M, for dropping the position of the second active metal 52 to near the position of the first active metal 51. The material recycling seat 17 can extend into the chamber base 12 in a push and pull way, for recycling an active alloy (e.g., nickel-titanium alloy) after the first and second active metals are molten.

The vacuum pump unit 2 is physically connected to the vacuum pump connection port 121, for making the melting chamber 1 form with a vacuum confined space. The vacuum confined space is defined by the working pipe 11, the chamber base 12, the pipe cover 15 and the chamber door 13, and the vacuum pump unit 2 is used for vacuumizing the vacuum confined space, making the vacuum degree in the working pipe 11 below a pressure of 10⁻⁵ Torr. The high-frequency furnace 3 includes an induction coil 3 which surrounds the working pipe 11. The inert gas supply unit 4 is communicated with the melting chamber 1 via the gas inlet hole 122, for introducing an inert gas into the working pipe 11.

The first bracket 14 can include a refractory bracket body 141 and a support frame 142. The support frame 142 is physically connected to the refractory bracket body 141, the refractory bracket body 141 is used for placing the first active metal 51, and the support frame 142 is used for driving the refractory bracket body 141 to move from the chamber base 12 into the working pipe 11. The refractory bracket body 141 can be made of alumina (Al₂O₃), and the support frame 142 can be made of metal.

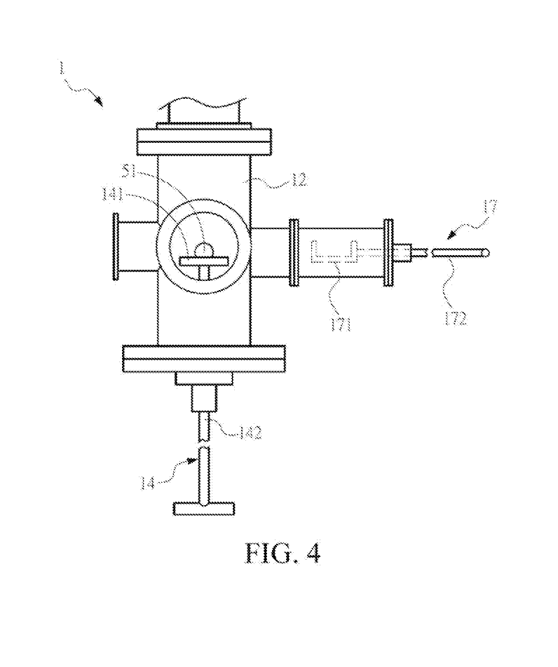

The second bracket 16 can also include a refractory bracket body 161 and a support frame 162. The support frame 162 is physically connected to the refractory bracket body 161, the refractory bracket body 161 is used for placing the second active metal 52, and the support frame 162 is used for driving the refractory bracket body 161 to move. The material recycling seat 17 can also include a recycling seat body 171 (as shown in FIG. 4) and a support frame 172. The support frame 172 is physically connected to the recycling seat body 171, the recycling seat body 171 is used for receiving the molten active alloy (e.g., nickel-titanium alloy), and the support frame 172 is used for driving the recycling seat body 171 to move.

In this embodiment, the working pipe 11 is a quartz pipe, for clearly observing the molten condition inside the active alloy material during melting. The vacuum pump unit 2 is used for vacuumizing a vacuum confined space of the melting chamber 1. The refractory bracket body 141 (located in the quartz pipe) of the first bracket 14 is used for placing a high melting point material (titanium material). If the refractory bracket body 141 is made of a metal material, it may be molten due to high-frequency induction heating, and thus a refractory material has to be used for the bracket. The refractory bracket body 141, upon turning, is screwed with the support frame 142. As the support frame 142 cannot enter a magnetic field induction area of the induction coil, a metal material with higher toughness can be selected for the support frame 142 to be used as support. On one hand, the recycling seat body 171 of the material recycling seat 17 can use copper to take away the high temperature of the molten active alloy material; on the other hand, the copper can also effectively avoid contamination. The chamber door 13 is mainly for placing an inlet of a high melting point material (e.g., titanium material) and an outlet through which the molten active alloy material is taken away. The refractory bracket body 161 of the second bracket 16 is used for placing a low melting point material (nickel material), and passes through the pipe cover 15. The refractory bracket body 161 can place the low melting point material (nickel material) to be molten on an upper side in the melting chamber 1 before the levitation melting process starts, and facilitate adding the low melting point material (nickel material) during alloy melting. The vacuum sensor 123 is used for rapidly knowing the condition of the vacuum degree in the working pipe 11 of the melting chamber 1, to facilitate introduction time and volume of the subsequent gas. The gas inlet hole 122 can be used for introducing multiple groups of different gases at the same time, and match appropriate active alloy to introduce predetermined reaction gases and protective gases. The chamber base 12 further includes a transparent window (e.g., an opening similar to the gas inlet hole 122 or vacuum pump connection port 121), and can be used for observing the positioning of the refractory bracket body 141 and the support frame 142 entering into the quartz tube through the window.

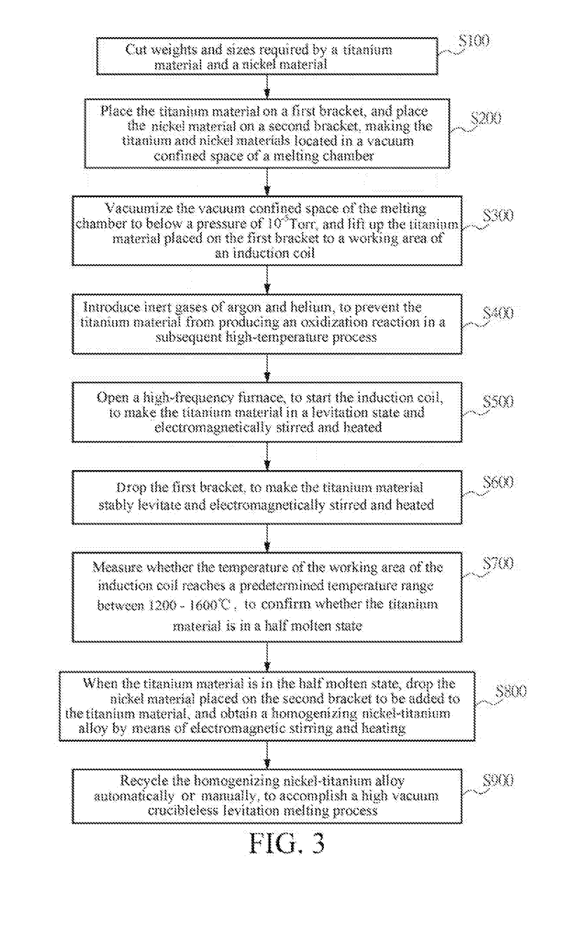

FIG. 3 is a flowchart of a method for manufacturing a nickel-titanium alloy using a high vacuum crucibleless levitation melting process according to an embodiment of the present disclosure. Referring to FIG. 3 and FIG. 1 at the same time, a method for manufacturing a nickel-titanium alloy of the present disclosure using a high vacuum crucibleless levitation melting process mainly includes the following steps:

Step S100: Cut weights and sizes required by a titanium material and a nickel material. In detail, before all procedures of the levitation melting process are performed, it is necessary to cut weights and sizes required by titanium and nickel materials in this levitation melting process. The design point of the present disclosure mainly focuses on overall homogenizing distribution of the nickel-titanium alloy after completion of refinement and melting; after completion of cutting of all the titanium and nickel materials, it is necessary to confirm that titanium and nickel materials to be molten has been cleaned by acetone and alcohol, and the subsequent procedures of the levitation melting process can be performed.

Step S200: Place a titanium material on a first bracket, and place a nickel material on a second bracket, making the titanium material and the nickel material located in a vacuum confined space of a melting chamber, wherein a melting point of the first active metal is greater than that of the second active metal. In detail, referring to FIG. 4, a chamber door 13 is opened, and the titanium material is placed on the refractory bracket body 141 (e.g., a platform made of an alumina, Al₂O₃) of the first bracket 14. Moreover, a pipe cover 15 (which can be referred to as a second material clamp seat) is opened, and the nickel material is placed on the refractory bracket body 161 (e.g., a hook made of an alumina, Al₂O₃) of the second bracket 16, so that the nickel material can be added to the titanium material when the titanium material is subsequently in a high-temperature half molten state. Then, the chamber door 13 and the pipe cover 15 are closed, making the nickel and the titanium materials located in a vacuum confined space defined by the working pipe 11 of the melting chamber 1, the chamber base 12, the pipe cover 15 and the chamber door 13.

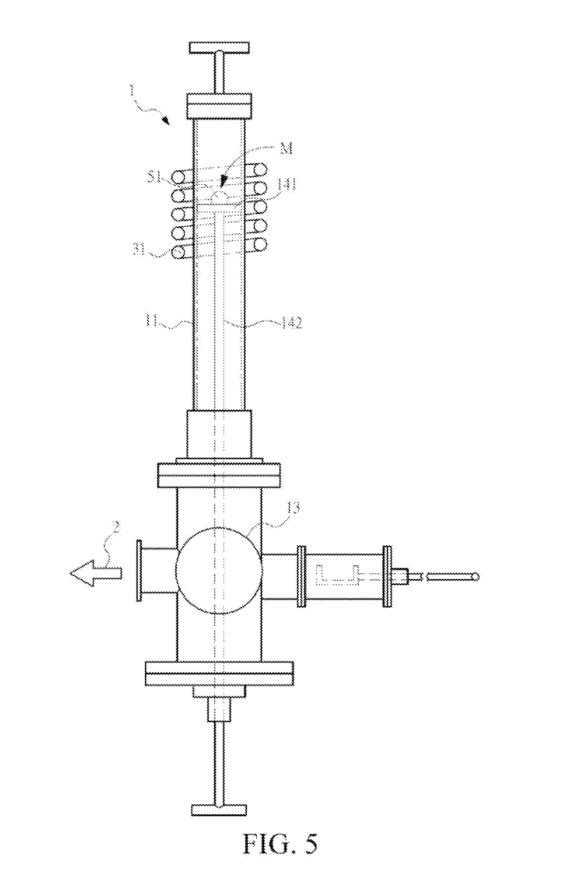

Step S300: Vacuumize the vacuum confined space of the melting chamber to below a pressure of 10⁻⁵ Torr, and lift up the titanium material placed on the first bracket to a working area of an induction coil. In detail, when the titanium and the nickel materials are completely in place and located in the melting chamber 1, rough pumping and fine pumping steps of the vacuum pump unit 2 are performed. During vacuumization, the titanium material can be lifted up to the working area M of the induction coil 31, as shown in FIG. 5. As the induction coil 31 surrounds the working pipe 11 of the melting chamber 1, the working area M of the induction coil 31 is the working area M of the working pipe 11. For example, by connecting a support frame 142 (e.g., metal support frame) to the refractory bracket body 141, the support frame 142 is pushed to drive the refractory bracket body 141, thus lifting up the titanium material to the working area M of the induction coil 31. The vacuum degree is observed via the vacuum sensor, and if the vacuum degree is below the pressure of 10⁻⁵ Torr, a high vacuum crucibleless levitation melting process test can be carried out.

The vacuum pump unit 2 of the present disclosure includes a diffusion pump and a turbo pump. The diffusion pump is responsible for the rough pumping step in a vacuum degree interval of the atmospheric pressure to a pressure of 10⁻³ Torr, and the turbo pump is responsible for the fine pumping step in a vacuum degree interval of a pressure of 10⁻³ Torr to 10⁻⁶ Torr. As the chamber has better air impermeability, it helps to enhance the vacuum degree considerably. When the vacuum degree is below a pressure of 10⁻⁵ Torr, the vacuum pump unit 2 can be closed.

Step S400: Introduce inert gases of argon and helium, to prevent the titanium material from producing an oxidization reaction in a subsequent high-temperature process. In detail, a predetermined reaction gas type is introduced via the gas inlet hole 122, and material can produce different oxidization and reduction reactions according to different inert gases and reduction gases. The high vacuum crucibleless levitation melting process test prevents the titanium material producing an oxidization reaction in a high-temperature levitation melting process test through inert gases (e.g., argon and helium).

Step S500: Open a high-frequency furnace, to start the induction coil, to make the titanium material in a levitation state and electromagnetically stirred and heated. In detail, when the inert gas is introduced for one minute, the high-frequency furnace 3 can be opened to start the induction coil 31, and a high-frequency parameter is set as 75% power. The maximum power of the high-frequency furnace 3 used in the high vacuum crucibleless levitation melting process of the present disclosure is 35 kW, a frequency interval of the high-frequency furnace 3 is 30 kHz to 80 kHz, and the working frequency interval can vary with the change of the coil design. Moreover, the coil design of the present disclosure is a result obtained by conducting numerical simulation and experimental validation through COMSOL simulation software, and is used in the high vacuum crucibleless levitation melting process experiment.

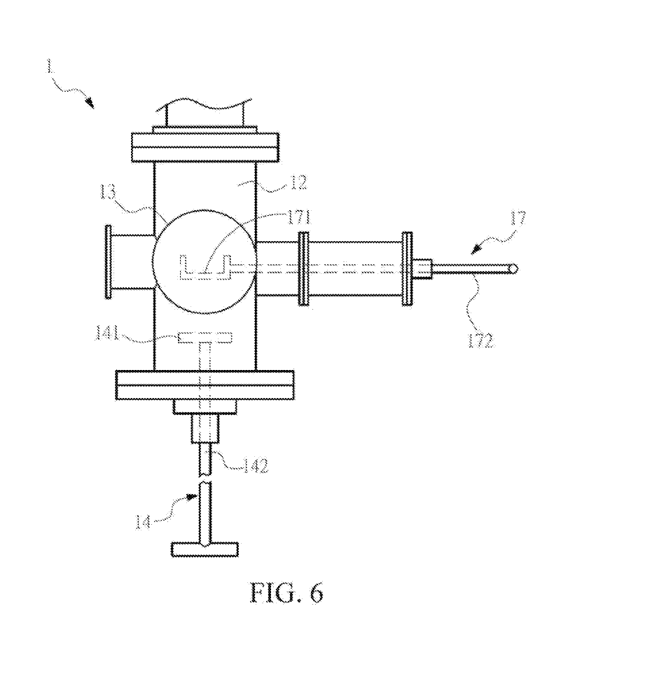

Step S600: After the high-frequency furnace is opened and the first active metal (titanium material) is in a levitation state, drop the first bracket, to make the titanium material stably levitate and electromagnetically stirred and heated. Step S610: after the refractory bracket body 141 of the first bracket 14 is dropped, a recycling seat body 171 of a material recycling seat 17 can be pushed to the middle of the chamber base 12 of the melting chamber 1, as shown in FIG. 6. After the levitation melting process test is in a high-temperature state and completed, the material recycling seat 17 is used for recycling the molten titanium-nickel alloy. In this embodiment, the recycling seat body 171 of the material recycling seat 17 can facilitate fetching the nickel-titanium alloy. Alternatively, in another embodiment, the recycling seat body 171 of the material recycling seat 17 is a shape-forming mold, and after the levitation melting process experiment is in a high-temperature state and completed, the homogenizing nickel-titanium alloy can be directly formed into a predetermined shape. The recycling seat body 171 of the material recycling seat 17 is made of red bronze.

Step S700: Measure whether the temperature of the working area of the induction coil reaches a predetermined temperature range about between 1200-1600 [symbol] whether the titanium material is in a half molten state. In detail, when the titanium material is stably levitated and heated, a non-contact infrared temperature measuring gun (i.e., temperature sensor) can be used to measure the temperature at the interior of the melting chamber 1 approximately fed back currently (i.e., the temperature at the interior of the melting chamber 1 is transmitted to the working pipe 11). The non-contact infrared temperature measuring gun makes correction and simulated contrast multiple times, and the difference between the actual temperature presented at the interior of the melting chamber 1 and the temperature fed back by the interior of the melting chamber 1 is about 200-300 [symbol] the melting chamber 1 is in a high vacuum state and lacks heat transfer medium, such that the temperature measured by the infrared temperature measuring gun is the temperature of an outer wall of the working pipe 11 of the melting chamber 1. However, a thermocouple or other non-contact temperature measuring devices can lead to temperature jump due to induction of the induction coil, such that they cannot be used in the levitation melting process experiment.

Step S800: When the titanium material is in the half molten state, drop the nickel material placed on the second bracket to be added to the titanium material, and obtain a homogenizing nickel-titanium alloy by means of electromagnetic stirring and heating. In detail, with increase of the temperature, the titanium material is gradually in the half molten state, and at this time, the refractory bracket body 161 of the second bracket 16 can be used to make the nickel material placed on an upper side in the melting chamber 1 slowly approach and added to the titanium material. As the melting point of the titanium is 1680° C. and the [symbol] of the nickel is 1455 [symbol] C. the nickel material having a lower melting point can have a faster diffusion rate in high temperature environments. At this time, the non-contact levitation melting process makes the titanium-nickel alloy obtain a better homogenizing effect by means of electromagnetic stirring and heating.

Step S900: Recycle the homogenizing nickel-titanium alloy automatically or manually, to accomplish a high vacuum crucibleless levitation melting process. The flow of the levitation melting process can be divided into automatic and manual modes. The automatic mode refers to giving no time limit until the temperature of the homogenizing nickel-titanium alloy reaches the Curie temperature and the nickel-titanium alloy falls inside the recycling seat body 171 of the material recycling seat 17. The manual mode refers to setting shutdown time of the high-frequency furnace and manually operating shutdown time of the melting chamber, to make the homogenizing nickel-titanium alloy fall inside the recycling seat body 171 of the material recycling seat 17. Step S910: when the homogenizing nickel-titanium alloy is recycled, helium is introduced to make the homogenizing nickel-titanium alloy quickly cooled down to a general room temperature within several seconds, so as to avoid a segregation effect produced by slow cooling of the nickel-titanium alloy material. Alternatively, step S920: when the homogenizing nickel-titanium alloy is recycled, the recycling seat body 171 of the material recycling seat 17 is a water-cooling mold, and the homogenizing nickel-titanium alloy is quickly cooled down, so as to avoid a segregation effect produced by slowly cooling of the nickel-titanium alloy. Finally, the chamber door 13 is opened and the molten homogenizing nickel-titanium alloy is fetched.

The high vacuum crucibleless levitation melting process refers to a technology with which the device and method for manufacturing an active alloy of the present disclosure use electromagnetic fields to make the nickel-titanium alloy in a levitation state and heated during high vacuum melting. The high vacuum melting technology eliminates contamination of gas molecules to the nickel-titanium alloy, and the levitation melting technology further eliminates contamination caused by the crucible on this basis. The high vacuum crucibleless electromagnetic levitation melting eliminates contamination of gas molecules and the crucible, and is an ideal technology for manufacturing medical alloy material.

The above merely describes implementations or embodiments of technical means employed by the present disclosure to solve the technical problems, which are not intended to limit the patent implementation scope of the present disclosure. Equivalent changes and modifications in line with the meaning of the patent scope of the present disclosure or made according to the scope of the disclosure patent are all encompassed in the patent scope of the present disclosure.

What is claimed is:

1. A method for manufacturing a nickel-titanium alloy using a high vacuum crucibleless levitation melting process, the method comprising:
step A: placing a titanium material on a first bracket, and placing a nickel material on a second bracket, so as to make the titanium nickel and materials located in a vacuum confined space of a melting chamber;
step B: vacuumizing the vacuum confined space of the melting chamber to below a pressure of 10⁻⁵ Torr, and lifting up the titanium material placed on the first bracket to a working area of an induction coil;
step C: introducing inert gases, to prevent the titanium material from producing an oxidization reaction in a subsequent high-temperature process;
step D: starting the induction coil, to make the titanium material in a levitation state and electromagnetically stirred and heated;
step E: dropping the first bracket, to make the titanium material stably levitate and electromagnetically stirred and heated;
step F: measuring whether the temperature of the working area of the induction coil reaches a predetermined temperature range between 1200-1600° C., to confirm whether the first active metal is in a half molten state;
step G: when the first active metal is in the half molten state, dropping the nickel material placed on the second bracket to be added to the titanium material, and obtaining a homogenizing nickel-titanium alloy by means of electromagnetic stirring and heating; and
step H: recycling the homogenizing nickel-titanium alloy automatically or manually, to accomplish a high vacuum crucibleless levitation melting process.

2. The method for manufacturing a nickel-titanium alloy using a high vacuum crucibleless levitation melting process according to claim 1, wherein:
in step H, the automatic mode refers to giving no time limit until the temperature of the homogenizing nickel-titanium alloy reaches the Curie temperature and the nickel-titanium alloy falls inside the recycling seat body of the material recycling seat.

3. The method for manufacturing a nickel-titanium alloy using a high vacuum crucibleless levitation melting process according to claim 1, wherein:
in step H, the manual mode refers to setting shutdown time of the high-frequency furnace and manually operating shutdown time of the melting chamber, to make the homogenizing nickel-titanium alloy fall inside the recycling seat body of the material recycling seat.

4. The method for manufacturing a nickel-titanium alloy using a high vacuum crucibleless levitation melting process according to claim 1, the method further comprising:
After step H, when the homogenizing nickel-titanium alloy is recycled, introducing helium to make the homogenizing nickel-titanium alloy quickly cooled down to a general room temperature within several seconds.

5. The method for manufacturing a nickel-titanium alloy using a high vacuum crucibleless levitation melting process according to claim 1, the method further comprising:
After step H, when the homogenizing nickel-titanium alloy is recycled, the recycling seat body of the material recycling seat is a water-cooling mold, and the homogenizing nickel-titanium alloy is quickly cooled down.

6. The method for manufacturing a nickel-titanium alloy using a high vacuum crucibleless levitation melting process according to claim 1, the method further comprising:
before step A, cutting weights and sizes required by the titanium material and the nickel material.

7. The method for manufacturing a nickel-titanium alloy using a high vacuum crucibleless levitation melting process according to claim 1, the method further comprising:
after step E, pulling a recycling seat body of a material recycling seat to the middle of the chamber base of the melting chamber.

8. The method for manufacturing a nickel-titanium alloy using a high vacuum crucibleless levitation melting process according to claim 7, wherein the recycling seat body of the material recycling seat is a shape-forming mold, whereby the homogenizing nickel-titanium alloy is directly formed into a predetermined shape.

9. The method for manufacturing a nickel-titanium alloy using a high vacuum crucibleless levitation melting process according to claim 1, wherein the melting chamber comprises a working pipe, a chamber base, a pipe cover and a chamber door which define the vacuum confined space.

10. The method for manufacturing a nickel-titanium alloy using a high vacuum crucibleless levitation melting process according to claim 1, wherein the inert gas comprises argon and helium.
